(19) United States
(12) Patent Application Publication
(10) Pub. No.: US 2026/0358877 A1
(43) Pub. Date: Nov. 12, 2026

(54) ADVANCED POWER MANAGEMENT BUS ARBITRATION TECHNIQUES

(71) Applicant: Micron Technology, Inc., Boise, ID (US)

(72) Inventors: Liang Yu, Boise, ID (US); Leon Zlotnik, Camino, CA (US)

(21) Appl. No.: 19/668,059

(22) Filed: May 5, 2026

Related U.S. Application Data
(60) Provisional application No. 63/802,310, filed on May 8, 2025.

(51) Int. Cl. G06F 1/3234; G06F 1/3225; G06F 1/3296

(52) U.S. Cl. CPC G06F 1/3275; G06F 1/3225; G06F 1/3296

(57) ABSTRACT

Disclosed are advanced techniques for managing power allocation in computing systems, focusing on improving fairness and efficiency in power distribution among components. Methods are introduced such as dynamic reordering of components and controller instances on a peak power management (PPM) bus, interleaving controller instances with memory dies, and intelligent power token distribution based on workload priorities. These techniques ensure equitable access to power resources, prevent resource starvation, and optimize overall system performance. The system dynamically monitors power requests and releases, adjusting the allocation strategy to provide components with varied opportunities to claim power tokens, thereby enhancing the efficiency and reliability of power management in computing environments.

### PRIORITY APPLICATION

This application claims the benefit of priority to U.S. Provisional Application Ser. No. 63/802,310, filed May 8, 2025, which is incorporated herein by reference in its entirety.

### TECHNICAL FIELD

Embodiments pertain to power management systems in computing devices and components of computing devices. Some further embodiments relate to power management systems in memory devices such as NAND flash memory devices.

### BACKGROUND

Power management in computing systems is important for many reasons. For example, for mobile and portable computing devices that run on batteries, effective power management directly affects how long these devices can operate between charges, which affects user productivity and device usability. For other computing devices such as desktop devices all the way up to large data centers, reducing power consumption through effective management helps decrease energy usage, lowering both environmental impact and operating costs. This is particularly important as organizations face increasing pressure to reduce their carbon footprint and meet sustainability goals. In addition, excessive power usage leads to increased heat output, which can affect system reliability, performance, and component lifespan and necessitate additional cooling resources. Finally, exceeding power limitations can lead to system instability or failure. Effective power management ensures that available power is distributed appropriately to maintain stable operation while maximizing performance within the system's power constraints.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a diagram of a distributed release according to some examples of the present disclosure.

FIG. 2 illustrates a diagram of a distributed release according to some examples of the present disclosure.

FIG. 3 shows a rotation pattern of controller positions in a round-robin cycle according to some examples of the present disclosure.

FIG. 4 shows a rotation pattern of NAND die positions in a round-robin cycle according to some examples of the present disclosure.

FIG. 5 shows a memory device with a power management component according to some examples of the present disclosure.

FIG. 6 illustrates a computing system with components connected to a controller according to some examples of the present disclosure.

FIG. 7 illustrates an example computing environment including a memory system, in accordance with some examples of the present disclosure.

FIG. 8 illustrates a flowchart of a method of ensuring power allocation fairness according to some examples of the present disclosure.

FIG. 9 illustrates a flowchart of a method for modifying a PPM bus ordering to ensure fairness according to some examples of the present disclosure.

FIG. 10 illustrates a block diagram of an example machine upon which any one or more of the techniques (e.g., methodologies) discussed herein may be performed.

### DETAILED DESCRIPTION

In computing systems, components often must share a fixed power budget to perform their operations. Traditional approaches often rely on static power allocation, where each component is assigned a fixed portion of the total system power budget based on worst-case scenarios. A power budget is the total amount of electrical power allocated to a system or device, which is distributed among its components to ensure stable operation and optimal performance within the system's power constraints. This static allocation creates inefficiencies because components may be allocated more power than they actually need under typical operating conditions. For example, a system controller might be allocated a power value that assumes maximum temperature and peak performance conditions, even though these conditions rarely occur in practice. This overly conservative approach means that other system components may be unnecessarily constrained, operating with less power than could be available to them, which results in degraded performance.

In memory systems, this issue manifests when the memory controller is allocated power assuming worst-case conditions like maximum temperature and peak performance. In practice the controller often operates at lower temperatures and doesn't require its full power allocation. This results in other devices in the memory system, such as the NAND dies themselves, being unnecessarily limited in their operations, even though additional power is available.

In some systems, more advanced power control is used. For example, some systems, such as memory systems, may allocate power using peak power management (PPM) which operates using a communication protocol where components such as memory dies communicate power needs over a shared power management bus. In some examples, the system may use a round-robin protocol where each component takes turns communicating power needs and/or usage during defined time periods controlled by a common clock signal (ICLK). Each die, during its turn to communicate over the PPM bus, has the opportunity to claim an amount of the available power budget or release a previously claimed amount of the power budget. Each die also maintains information about the total power of all dies, enabling them to calculate available power budget.

Discrete units or portions of the power budget that are claimed from the PPM bus may be termed “power tokens.” Power tokens represent the ability to access and utilize a portion of the available power budget. Components thus claim power tokens by transmitting a claim in the form of an amount of power over the PPM bus. When a component holds a power token, it has the right to use a certain amount of power from the shared budget. The allocation of power tokens ensures that power is distributed among the components in a controlled manner, preventing any single component from monopolizing the power resources. By dynamically managing the distribution of power tokens, the system can optimize power usage and improve overall performance.

The PPM protocol allows dies to release power tokens back to the available budget when operations complete. When power is released, other dies become aware of the newly available budget through the PPM bus. The next die in the sequence can then claim the released power tokens if needed for its operations. For example, if there is a total budget of 1 amp shared across 8 dies, each die can request power during its turn on the PPM budget. If the first die requests power tokens corresponding to 200 mA and the second requests 500 mA, they can claim that power since sufficient budget remains. However, if a third die needs more power than the remaining 300 mA budget, it must wait until other dies release their claimed power tokens.

In some example memory systems, the NAND dies are on the PPM bus, but the controller is not on the PPM bus. In the examples, the controller may utilize statically allocated power budgets. That is, the power for the NAND dies may be calculated as the remainder of the total budget of the device and the portion reserved for the controller. As noted, this can hinder performance when the controller does not need all of the static fixed budget.

In some examples, to make more efficient usage of the power budget of the memory device, a controller may be connected to a PPM bus and may claim and release power tokens corresponding to its current or projected power usage so that total system power may be better regulated and reductions in performance may be reduced. However, when the system controller requires more power than is currently available in the system power budget, the controller may have to wait until other components naturally complete their operations and release power back to the available budget. Moreover, it may be possible for another component to claim the released power tokens before the controller. This waiting period can significantly impact system performance and responsiveness, particularly when the controller needs to perform time-sensitive operations.

For example, in a system with a total power budget of 1 amp shared across multiple components, if the first component requests 200 mA and the second requests 500 mA, they can claim that power since sufficient budget remains. However, if the controller then needs more power than the remaining 300 mA budget, it must wait until other components complete their operations and release enough power tokens.

One solution for this problem is to assign multiple “instances” on the PPM bus to the controller. That is, the controller receives additional spots on the ring, and thus additional transmission token opportunities to claim power tokens from the PPM bus. This reduces the chances that power released by other components are taken before the controller can take them but does not eliminate the problem altogether. Even considering multiple instances, the controller must operate within the standard power management protocols, potentially leading to suboptimal system performance as it waits for power to become available through normal operation cycles.

Some systems may enable a system controller to pre-reserve power by claiming power tokens that exceed the currently available power budget. While these power tokens are transmitted as consumed, the controller waits until other components release sufficient power tokens before performing its operations. In the meantime, other components are not able to claim these tokens prior to the controller. This approach ensures the controller will receive the needed power as soon as it becomes available, rather than having to compete with other components after power is released, while maintaining system stability by not actually consuming the power until it is properly released.

One issue with allowing the controller to pre-reserve power in this manner is that dies having transmission opportunities on the PPM bus that are closest to controller instances have a greater chance of claiming the released tokens than dies that have transmission opportunities further away from the controller instances. For example, because the controller has absolute priority and because the NAND dies that have turns on the PPM bus nearest the controller will have the first opportunity to grab the power tokens relinquished by the controller, in a very busy system the NAND dies further from the controller on the PPM bus may have fewer opportunities to obtain the power they need. In some instances, this could lead to a denial-of-service type scenario where NAND dies at the end of the bus may not be able to obtain the power they need to complete the tasks they were assigned (e.g., writing data or reading data) or they may be very slow in completing those tasks.

Disclosed in some examples are methods, systems, devices, and machine-readable mediums for improving fairness in power budget allocation between NAND dies in memory systems using advanced arbitration schemes. Example advanced arbitration schemes include one or more of: 1. interleaving the controller instances on the PPM bus with NAND dies and randomly splitting power token requests or releases across different controller instances. 2. interleaving the controller instances on the PPM bus with NAND dies and intelligently determining, based upon the workloads (e.g., commands) the dies are handling, how to distribute power tokens for release to controller instances. 3.) re-ordering the turn of each die on the PPM bus periodically 4.) re-ordering the turn of a controller instance on the PPM bus periodically. These improvements address the problem of certain NAND dies being starved of resources when controller commands monopolize the available power budget, ensuring more consistent and efficient operation of the memory system.

### Interleaved Controller Instances and Random or Pre-Defined Distribution

In some examples, a power management system includes multiple controller instances distributed across a PPM bus to improve power budget allocation fairness. The controller instances are interleaved with memory dies on the bus, allowing for more equitable distribution of power resources. The system may utilize a resource manager that controls how power tokens are distributed amongst the different controller instances. The controller can utilize either random distribution or pre-defined methods to allocate the total requested power tokens across its multiple instances. For example, when a controller releases a large power token (such as 550 mA), instead of releasing it all through a single instance, the power can be released across multiple instances (e.g., 500 mA through one instance and 50 mA through another).

This distributed approach enables better power budget sharing between the controller and memory dies. When one controller instance releases its power tokens back to the budget pool, nearby memory dies have an increased opportunity to acquire those resources before another controller instance claims them. The token weight distribution can be implemented through random allocation or through circulation based on clock counters, providing flexibility in how power resources are managed.

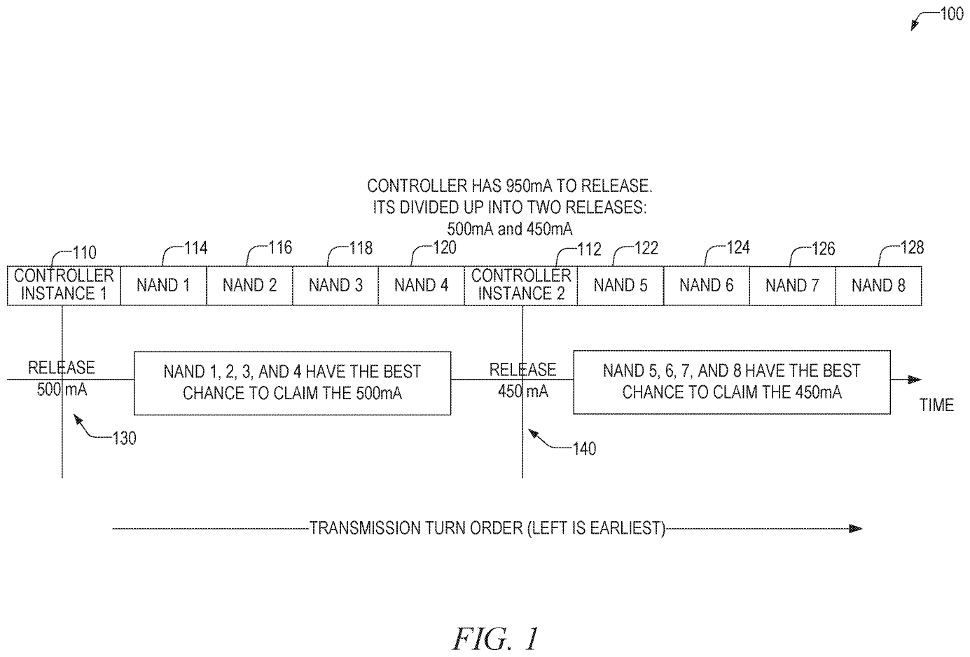

FIG. 1 illustrates a diagram of a distributed release 100 according to some examples of the present disclosure. Controller instance 1 110 is first on the PPM bus, followed by NAND die 1 114, NAND die 2 116, NAND die 3 118, and NAND die 4 120. Controller instance 2 112 follows NAND die 4 120. Following controller instance 2 112 is NAND die 5 122, NAND die 6 124, NAND die 7 126, and NAND die 8 128. The controller has a total of 950 mA to release during this round of the PPM round robin. The controller randomly splits the total into 500 mA and 450 mA. At time 130, the controller instance 1 110 releases 500 mA. This power may be claimed first by NAND die 1 114, followed by NAND die 2 116, and so on. Controller instance 2 112 at time 140 releases the remaining 450 mA which, along with any remaining power from the earlier 500 mA release that is unclaimed may be first claimed by NAND die 5 122, then NAND die 6 124 and so on.

### Interleaved Controller Instances and Smart Distribution

In some examples, a power management system includes multiple controller instances distributed across a PPM (Power Performance Management) bus, where the controller instances are interleaved with memory dies to enable intelligent power budget allocation. In these examples, the resource manager may actively detect commands being executed by the memory dies and use this information to make intelligent decisions about power token distribution among controller instances. For example, when the controller has power tokens to release and when memory dies are performing specific operations like erase operations, program operations, or cache read operations, the system can dynamically adjust power token allocation between controller instances, to release these power tokens with the controller instances that are closest to dies performing these prioritized operations in order to prioritize dies that require immediate power resources.

In some examples, the system may implement a dynamic token weight distribution mechanism where power tokens can be swapped between controller instances based on the detected memory die operations. For instance, if a controller power token of 550 mA needs to be distributed, the system might allocate different portions to different instances (such as 500 mA to one instance and 50 mA to another) based on which memory dies are performing high-priority commands. When these large power tokens are released, this ensures that nearby memory dies are prioritized and may immediately benefit from the available budget to complete their operations.

In some examples, the token weight system may use a score for each die. The score may be based upon the command that the NAND die is, or will soon be, executing—for example, based upon a predetermined mapping between commands and points. The score may also be based upon previous power usage of the NAND die. That is, the score may be reduced based upon the power the NAND die was allocated over a prespecified period of time such that higher previous power allocations may reduce the score more than lower previous power allocations.

Power released by the controller instances may be allocated based upon a score of the dies after the controller instance in the PPM bus. Thus, a controller instance with a die with a higher score may be allocated additional power to release. In some examples, the total power to be released in a round of the PPM bus may be divided amongst controller instances proportionally based upon the scores of the dies after them in the PPM bus.

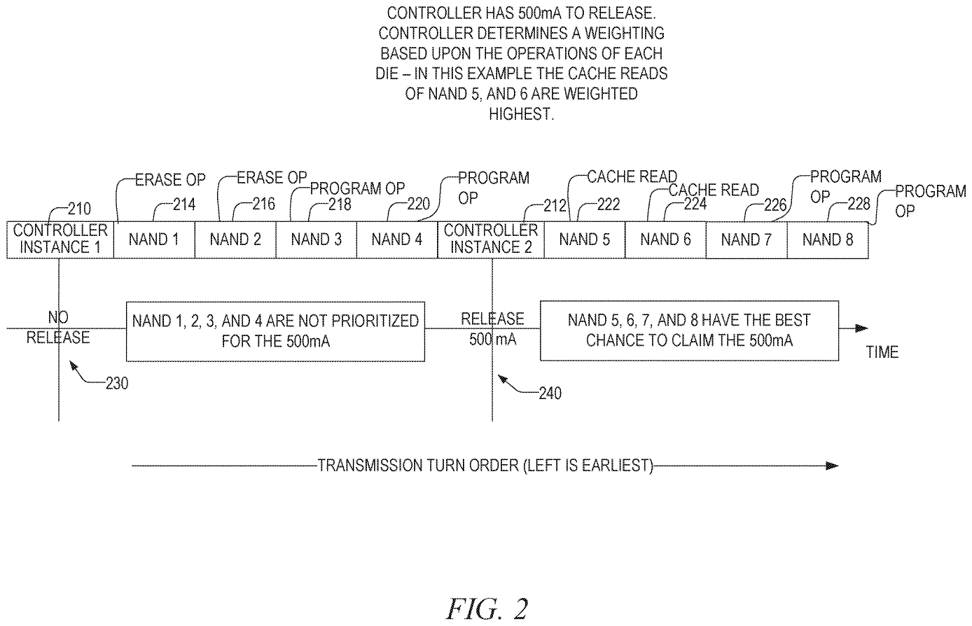

FIG. 2 illustrates a diagram of a distributed release 200 according to some examples of the present disclosure. Instead of the random distribution of FIG. 1, in FIG. 2, a smart distribution prioritizes controller instances based upon the operations performed by dies coming after them in the PPM bus. Controller instance 1 210 is first on the PPM bus, followed by NAND die 1 214, NAND die 2 216, NAND die 3 218, and NAND die 4 220. Controller instance 2 212 follows NAND die 4 220. Following controller instance 2 212 is NAND die 5 222, NAND die 6 224, NAND die 7 226, and NAND die 8 228. The operations performed by each particular die is indicated above the particular die. The controller has a total of 500 mA to release during this round of the PPM round robin. The controller determines that NAND dies 1-4 are all performing lower priority operations (e.g., erase operations and program operations) than NAND die 5 222 and NAND die 6 224 (cache read operations). In order to prioritize NAND die 5 222 and NAND die 6 224, at time 230, no power is allocated to controller instance 1 210 to release. NAND dies 1-4 may grab any remaining power that has not been claimed up until this point but cannot claim any newly available power. Controller instance 2 212 is granted all 500 mA to release and do so at time 240. This allows NAND die 5 222 and NAND die 6 224 to grab this power.

### Die/Clock Counter Re-Order

In some examples, the controller's turn on the PPM bus may be modified. That is, on a first round-robin cycle, the controller may be first on the PPM bus, but on subsequent cycles, the controller may have different turns on the bus. For example, on a second cycle, the controller may go second. On these later round robin turns where the controller's turn is later in the ring, when the controller releases power tokens to the bus, dies or other components further down the bus have a greater chance of grabbing the tokens.

In some examples, to implement this, the physical die PPM Logical Unit Number (LUN) is not changed. However, a die counter may be used to determine the dies turn, when the die counter maps to the LUN address of the die, the die is able to transmit on the PPM bus. The die counter update logic may re-order the turn of the controller and/or dies between round-robin turns. For example, for a four die system, with die counter 0 being the controller, the turns may be mapped as follows:

| Round | | | | | |
|---|---|---|---|---|---|
| Robin | | | | | |
| Turn | | | | | |
| 1 | Die Counter 0 | Die Counter 1 | Die Counter 2 | Die Counter 3 | Die Counter 4 |
| | (controller) | | | | |
| 2 | Die Counter 1 | Die Counter 0 | Die Counter 2 | Die Counter 3 | Die Counter 4 |
| | | (controller) | | | |
| 3 | Die Counter 1 | Die Counter 2 | Die Counter 0 | Die Counter 3 | Die Counter 4 |
| | | | (controller) | | |
| 4 | Die Counter 1 | Die Counter 2 | Die Counter 3 | Die Counter 0 | Die Counter 4 |
| | | | | (controller) | |
| 5 | Die Counter 1 | Die Counter 2 | Die Counter 3 | Die Counter 4 | Die Counter 0 |
| | | | | | (controller) |
| 6 | Die Counter 0 | Die Counter 1 | Die Counter 2 | Die Counter 3 | Die Counter 4 |
| | (controller) | | | | |

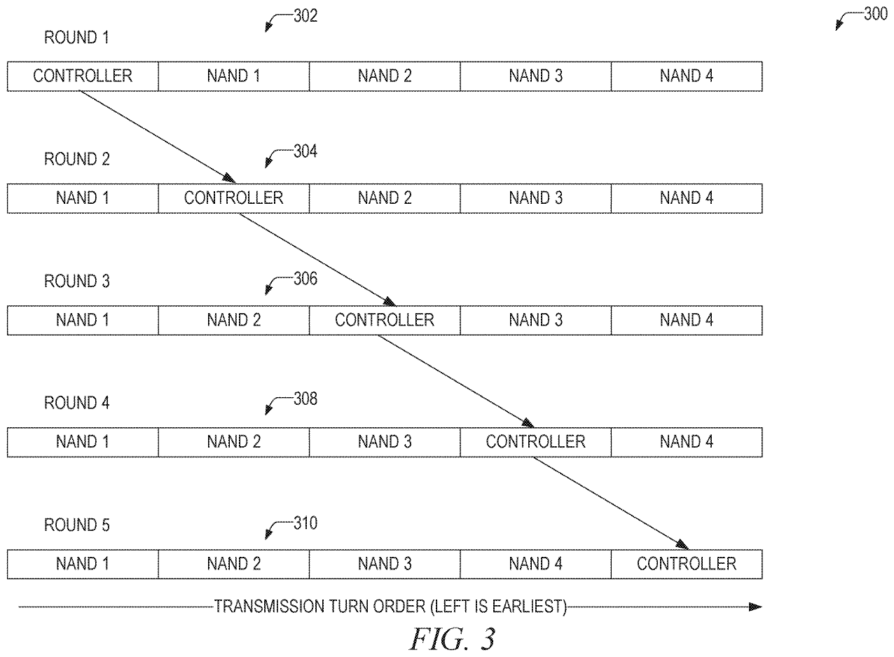

This rotation pattern is also illustrated in FIG. 3, where in round 1 302 the controller is in the first position, round 2 304 the controller is in the second position, round 3 306 the controller is in the third position, round 4 308, the controller is in the fourth position, and in round 5 310, the controller is in the last position.

The rotation pattern can be implemented through a predefined table (such as the one shown above) that determines how die counter assignments change in each round. For example, in one implementation, Die Counter 0 might map to Die Counter 1 in the next round, while Die Counter 1 maps to Die Counter 0, creating a dynamic reordering that promotes fair access to power resources. This approach can be particularly effective in preventing resource starvation by ensuring that all dies have equitable opportunities to access the power budget.

While the example above incremented the position of the controller by one each round-robin turn, a person of ordinary skill in the art will appreciate that additional schemes may be used. For example, incrementing the position by greater or lesser numbers, not incrementing the position of the controller every round robin turn, but every predetermined turn (e.g., every other turn, every third turn, etc . . . ), random re-ordering, smart re-ordering (e.g., based upon a workload of the dies as was mentioned before with respect to the smart distribution described above), and the like.

### NAND Re-Order

Rather than moving the controller's turn on the PPM bus, the ordering of the NAND dies may be modified each round robin turn. For example:

| Round | | | | | |
|---|---|---|---|---|---|
| Robin | | | | | |
| Turn | | | | | |
| 1 | Die Counter 0 | Die Counter 1 | Die Counter 2 | Die Counter 3 | Die Counter 4 |
| | (controller) | | | | |
| 2 | Die Counter 0 | Die Counter 2 | Die Counter 3 | Die Counter 4 | Die Counter 1 |
| | (controller) | | | | |
| 3 | Die Counter 0 | Die Counter 3 | Die Counter 4 | Die Counter 1 | Die Counter 2 |
| | (controller) | | | | |
| 4 | Die Counter 0 | Die Counter 4 | Die Counter 1 | Die Counter 2 | Die Counter 3 |
| | (controller) | | | | |
| 5 | Die Counter 0 | Die Counter 1 | Die Counter 2 | Die Counter 3 | Die Counter 4 |
| | (controller) | | | | |

As with the controller re-ordering, the physical die PPM Logical Unit Number (LUN) may not be changed. However, a die counter may be used to determine the dies turn, when the die counter maps to the LUN address of the die, the die is able to transmit on the PPM bus. The die counter update logic may re-order the turn of the controller and/or dies between round-robin turns.

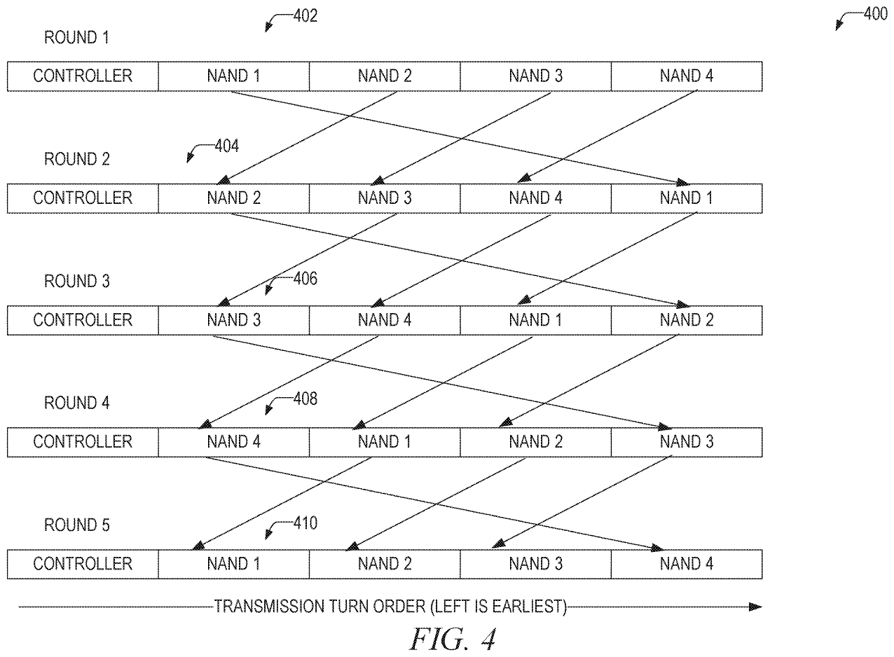

This rotation pattern is also illustrated in FIG. 4, where in round 1 402 NAND die 1 is in the first position, NAND die 2 is in the second position and so on. In round 2 404 NAND die 1 wraps around to the last position and NAND dies 2-4 shift over one position. In round 3 406 NAND die 2 wraps around to the last position and NAND dies 2, 3, and 1 shift over one position. In round 4 406 NAND die 3 wraps around to the last position and NAND dies 4, 1, and 2 shift over one position. Round 5 410 is the same ordering as round 1 402.

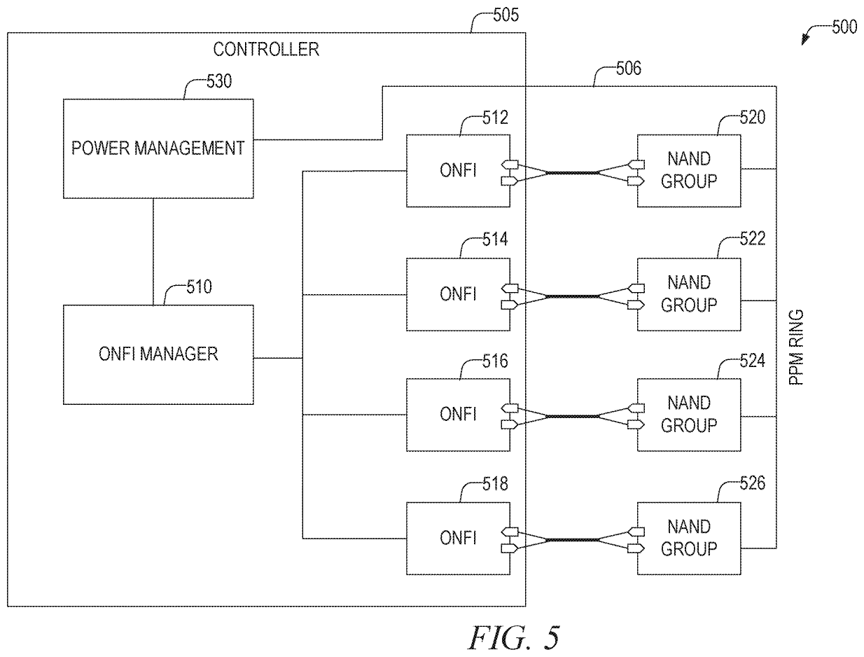

FIG. 5 shows a memory device 500 with a power management component 530 according to some examples of the present disclosure. The power management component 530 may communicate current or future power needs of the controller with the NAND dies over the PPM bus 506. The memory device 500 includes a controller 505 with an Open NAND Flash Interface (ONFI) Manager 510, which is responsible for managing the communication and control of multiple ONFI channels. The ONFI Manager 510 interfaces with four ONFI channels: ONFI Channel 512, ONFI Channel 514, ONFI Channel 516, and ONFI Channel 518. Each ONFI channel may be connected to corresponding one or more NAND dies. Specifically, ONFI Channel 512 is connected to NAND Die group 520, ONFI Channel 514 is connected to NAND Die group 522, ONFI Channel 516 is connected to NAND Die group 524, and ONFI Channel 518 is connected to NAND Die group 526. NAND die groups may include one or more NAND dies. These connections facilitate the transfer of data and control signals between the ONFI Manager 210 and the NAND dies.

As noted, the memory device 500 also includes a Power Management Component 530. The Power Management Component 530 interfaces with the ONFI Manager 510 to identify current or future power needs of the controller 505 to claim or release power tokens on the PPM bus 506 (which may be a token ring bus). Power management component 530 may include one or more instances on the PPM bus 506.

The ONFI Manager 510 coordinates the operations of the ONFI channels and the NAND dies, ensuring that data transfers and power management are performed efficiently. The ONFI channels 512, 514, 516, and 518 handle the communication with the respective NAND die groups 520, 522, 524, and 526, enabling the memory device 500 to perform read and write operations effectively.

As previously noted, the power management component 530 may claim power tokens for predicted or current power needs of the controller 505 whether or not the tokens put the device over the power limit. The power management component 530 may also communicate with the ONFI manager 510 to schedule and release transfers across the ONFI bus based upon the total power usage of the device. For example, by holding transactions which would violate the power limits until other components (e.g., the NAND dies) have released enough tokens.

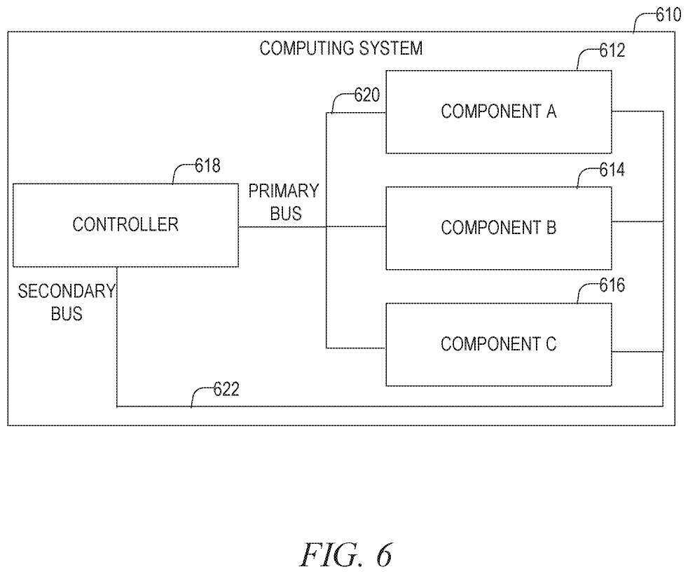

While the present disclosure has described the inventive techniques disclosed herein in the context of memory systems, a person of ordinary skill in the art will appreciate that these inventive techniques may be utilized with other systems as well. FIG. 6 illustrates a computing system 610 with three components: component A 612, component B 614, and component C 616. The three components are connected to a controller 618. The controller configures, receives status information from, and/or manages the components.

The primary bus 620 is a communication bus used primarily by the controller 618 to communicate data and operations with the components. For example, if the components are memory devices, the primary bus 620 may be used to communicate data stored in the memory devices. The controller may use a secondary bus 622, which is also a communication bus, to communicate one or more of status information, management commands, configuration commands, power management commands, or the like. In some examples, the controller 618, component A 612, component B 614, and component C 616 may claim and release power tokens from the secondary bus 622. In some examples, the controller 618 may claim power tokens in excess of the power budget of the computing system 610. The controller 618 may wait until other components have released power tokens such that the system is below or equal to the power budget before using those tokens to perform operations.

Controller, component A 612, component B 614, and/or component C 616 may be software components or hardware components (e.g., logic circuits such as an Application Specific Integrated Circuit (ASIC)). In some examples, the controller, component A 612, component B 614, and/or component C 616 may be on a same device. In other examples, one or more of the components and the controller 618 may be, or be located on, different devices. In some examples, the communication buses (e.g., either or both of primary bus 620 and secondary bus 622) may be local busses such as Peripheral Component Interconnect (PCI), Universal Serial Bus, memory busses, token ring busses, ethernet busses, and the like. In other examples, the buses may be remote busses such as those facilitating communication between devices. For example, a CXL bus.

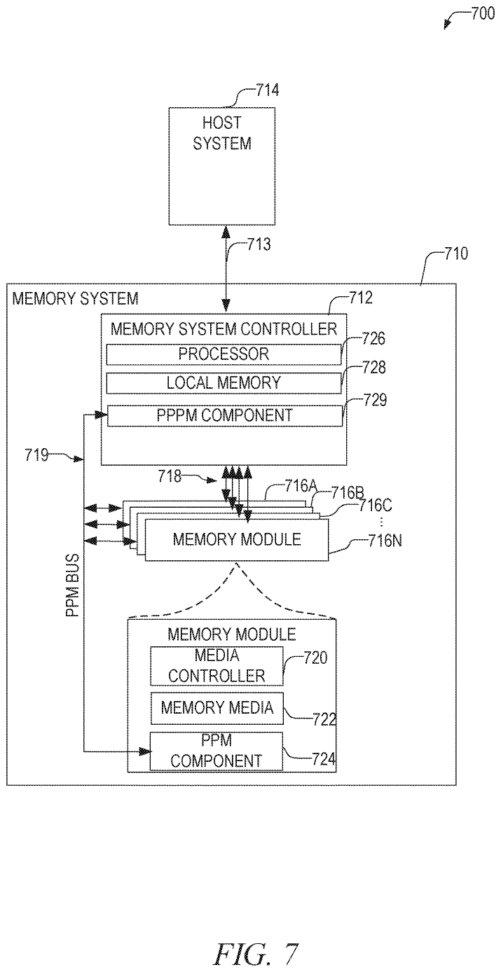

FIG. 7 illustrates an example computing environment 700 including a memory system 710, in accordance with some examples of the present disclosure. In some examples, the memory system 710 can be volatile storage such as Random Access Memory (RAM), cache memory, dynamic RAM (DRAM), synchronous DRAM (SDRAM), double data rate SDRAM (DDR), static RAM (SRAM), Graphics DDR (GDDR), or the like. In some examples, the memory system 710 can be non-volatile storage such as a Not-AND (NAND) flash, NOR flash, magnetic storage (e.g., a hard-disk drive), tape storage, or the like. In some examples, the memory system 710 can include both volatile and non-volatile storage, by utilizing, for example, memory modules 716A-N containing different types of memory media 722 or by utilizing one or more single memory modules that include both volatile and non-volatile memory media 722. The memory system 710 may be an error-correcting memory system in that at least some of the memory media 722 includes error correcting memory.

In an example, the memory system 710 can be a discrete memory and/or storage device component of a host system. In other examples, the memory system 710 can be a portion of an integrated circuit (e.g., system on a chip (SOC), etc.), stacked or otherwise included with one or more other components of a host system. In some examples, the memory system 710 may be part of a distributed memory system with multiple memory systems 710 and multiple host systems that may each include one or more processors. For example, a distributed memory system may operate according to a Compute Express Link (CXL) framework, such as a CXL.mem framework. The memory system may also have compute capabilities to support compute-near-memory functionalities—e.g., by using the processor 726 of memory system controller 712, media controller 720, or some other processor that is not shown.

As noted, the host 714, as well as memory system 710 can be integrated into a single host computing system. The host system can be in the form of a desktop computer, laptop computer, network server, mobile device, or such computing device that includes a memory and a processing device. The host system and/or the memory system 710 can be included in a variety of products, such as IoT devices (e.g., a refrigerator or other appliance, sensor, motor or actuator, mobile communication device, automobile, drone, etc.) to support processing, communications, or control of the product. The host system can include or be coupled to the host 714 and to the memory system 710 so that the host system can read data from or write data to the memory system 710. As used herein, “coupled to” generally refers to a connection between components, which can be an indirect communicative connection or direct communicative connection (e.g., without intervening components), whether wired or wireless, including connections such as, electrical, optical, magnetic, and the like.

The memory system 710 is configured with a memory system controller 712 that interfaces with the host 714. The host 714 may include a hardware processor, which may be a multi-core hardware processor, and communicates with the memory system controller 712 via a memory controller interface 713. Through this interface, the host 714 can issue commands to the memory system controller 712, such as a request to store data, which is accompanied by the data itself and potentially the target memory address for storage. In response, the memory system controller 712 can acknowledge the command and execute the data storage operation, providing confirmation back to the host 714 through the memory controller interface 713. Similarly, the host 714 can send a command to retrieve data, specifying the memory address from which to load the data. Upon receiving such a command, the memory system controller 712 retrieves the requested data and delivers it to the host 714 through the memory controller interface 713.

In certain embodiments, the host 714 and the memory system controller 712 are integrated onto a single die or different dies, but within a unified package. For example, in systems based on the x86 architecture, the memory system controller 712 is typically on the same die as the processor cores of host 714, thereby streamlining the memory access operations. Alternatively, there are configurations where the memory system controller 712 is situated on a distinct die, separate from that of the host 714 but within the same CPU package, allowing for modular design and potential customization of the memory system. In yet other examples, the memory system controller 712 may not be on the same die or package as the host 714.

The host 714 may communicate with the memory system controller 712 through a memory controller interface 713 and the memory system controller 712 may communicate with one or more memory modules 716A-716N upon which the physical memory is located through the memory module interface 718. In examples in which the memory system controller 712 is not on the same die or package as the host 714, the memory controller interface 713 may be the system bus, front-side bus, or other interface and the memory module interface 718 may be an internal bus of the memory system 710, such as internal pins or traces or some other interface such as an ONFI bus. In other examples, where the memory system controller 712 is on a same die or package as the host 714, the memory controller interface 713 may be one or more traces, pins, or some other interface and the memory module interface 718 may be a system bus.

The memory controller interface 713 and/or the memory module interface 718 may, depending on the design of the system, operate as one or more traces or pins, a Peripheral Component Interconnect-Express (PCIe) interface, a UFS interface, a serial advanced technology attachment (SATA) interface, a universal serial bus (USB) interface, an ONFI interface, a Fibre Channel interface, Serial Attached SCSI (SAS) interface, memory fabric, an eMMC interface, or the like.

The memory modules, designated as 716A through 716N, are capable of incorporating a diverse array of memory media 722, which may be either volatile or non-volatile in nature. The memory media 722 is comprised of elements such as memory cells, magnetic sectors, or equivalent data storage units. These memory modules can manifest in various configurations, including but not limited to Single Inline Memory Modules (SIMMs), Dual Inline Memory Modules (DIMMs), Solid State Drives (SSDs), embedded MultiMediaCards (eMMCs), Hard Disk Drives (HDDs), tape drives, among others. The memory media 722 within modules 716A-716N may encompass Random Access Memory (RAM), Static RAM (SRAM), Dynamic RAM (DRAM), Synchronous DRAM (SDRAM), NAND flash memory, magnetic media, phase-change memory (PCM), magneto-resistive random access memory (MRAM), NOR flash memory, electrically erasable programmable read-only memory (EEPROM), cross-point memory, and similar technologies. For instances where the memory media 722 consists of NAND-type memory, the configuration may involve a range of cell architectures, from single-level cells (SLCs) to multi-level cells (MLCs). MLCs may include triple-level cells (TLCs), quad-level cells (QLCs), and the like.

In some examples, the data storage units of the memory media 722 (such as memory cells) may be organized into one or more logical structures. For volatile storage, one example of a logical organization groups memory cells by ranks, banks, rows, and columns. For non-volatile storage, one example logical organization includes grouping cells into planes, sub-blocks, blocks, and/or pages. Other logical organizations may include sectors, tracks, cylinders, clusters, and so on.

In some examples, one or more of the memory modules 716A-716N may include a media controller 720 that may handle tasks such as accessing data from the memory media, writing data to the memory media, refreshing memory cells and communications over the memory module interface with the memory system controller 712. For example, the media controller 720 can parse a command and determine the affected memory cells from the memory media 722 and can read and/or write a desired value to those memory cells. Media controller 720 can be responsible for refreshing or otherwise maintaining the data stored in the memory media 722. In some examples, the media controller 720 may handle one or more of the functions traditionally associated with the memory system controller 712. In some examples, the memory modules 716A-N do not include a media controller 720.

The media controller 720 can include hardware such as one or more integrated circuits and/or discrete components, a buffer memory, or a combination thereof. The media controller 720 can be a microcontroller, special purpose logic circuitry (e.g., a field programmable gate array (FPGA), an application specific integrated circuit (ASIC), etc.), or other suitable processor(s). The media controller 720 can include a processor (processing device) configured to execute instructions stored in a local memory. Media controller 720 can also include address circuitry, row decoders, I/O circuitry write circuitry, column decoders, sensing circuitry, and other latches for decoding addresses, writing to, and reading from the memory media 722.

The local memory of the media controller 720 can include embedded memory configured to store instructions for performing various processes, operations, logic flows, and routines that control the memory media 722, including handling communications between the memory module 716A-716N and the memory system controller 712. In some embodiments, the local memory of the media controller 720 can include memory registers storing, e.g., memory pointers, fetched data, etc. The local memory can also include read-only memory (ROM) for storing micro-code.

The memory system controller 712 (controller) can include a processor 726 configured to execute instructions stored in a local memory 728. The processor 726 can be a microcontroller, special purpose logic circuitry (e.g., a field programmable gate array (FPGA), an application specific integrated circuit (controller), etc.), general purpose processor configured by software (e.g., firmware), or other suitable processor. In the illustrated example, the local memory 728 may store instructions for performing various processes, operations, logic flows, and routines that control operation of the memory system 710, including handling communications between the memory system 710 and the host 714 and communications between the memory system controller 712 and the memory modules 716A-716N. In some embodiments, the local memory 728 of the memory system controller 712 can include memory registers storing, e.g., memory pointers, fetched data, etc. The local memory can also include read-only memory (ROM) for storing micro-code.

Local memory 728 may also include various management tables such as translation tables translating logical addresses used by the host 714 into physical memory addresses that define a physical location of the memory cells. In other examples, the management tables can instead or additionally include information regarding block age, block erase count, error history, or one or more error counts (e.g., a write operation error count, a read bit error count, a read operation error count, an erase error count, etc.) for one or more blocks of memory cells coupled to the memory system controller 712.

As noted, the memory system controller 712 can receive commands or operations (memory access commands) from the host 714 (or other component of a host) and can convert the commands or operations into instructions or appropriate commands to achieve the desired access to the memory modules 716A to 716N. The memory system controller 712 can be responsible for other operations such as wear leveling operations (e.g., garbage collection operations, reclamation), error detection and error-correcting code (ECC) operations, refresh operations, encryption operations, caching operations, block retirement, and address translations between a logical block address and a physical block address that are associated with the memory modules 716A to 716N. The memory system controller 712 can further include interface circuitry to communicate with the processor via the memory controller interface 713. The interface circuitry can convert the commands received from the host 714 into command instructions to access the memory modules 716A to 716N over the memory module interface 718 as well as convert responses associated with the memory modules 716A to 716N into information for the host 714 or other component of the host system.

The memory system controller 712 may include or be coupled to a PPM component 729 for participating in the power management scheme with the one or more memory modules 716A-716N over the PPM bus 719. The PPM component 729 may monitor controller power needs (either current or predicted future needs), as well as temperature and other operational metrics of the memory system 710 and adjust the controller power draw by claiming or releasing tokens on the PPM bus 719. As noted, the PPM component 729 may claim power tokens in excess of the power budget of memory system 710. In these examples, the memory system controller 712 may wait until one or more memory modules release enough power tokens that the performance of the operations for which the power tokens were claimed would not put the memory system 710 over the power budget. In some examples the PPM component 729 may handle re-ordering of the PPM bus 719 according to the schemes disclosed herein.

In some examples, each memory module 716 may have a PPM component 724. In some examples, each memory module 716 may have multiple dies which may each have a PPM component 724. In some examples, instead of a discrete controller, the functionality of the PPM component 729 may be implemented by a component—e.g., a hardware or software component. PPM component 724 determines current or predicted future power needs of the memory module and claims and releases power tokens on the PPM bus 719 in accordance with these needs.

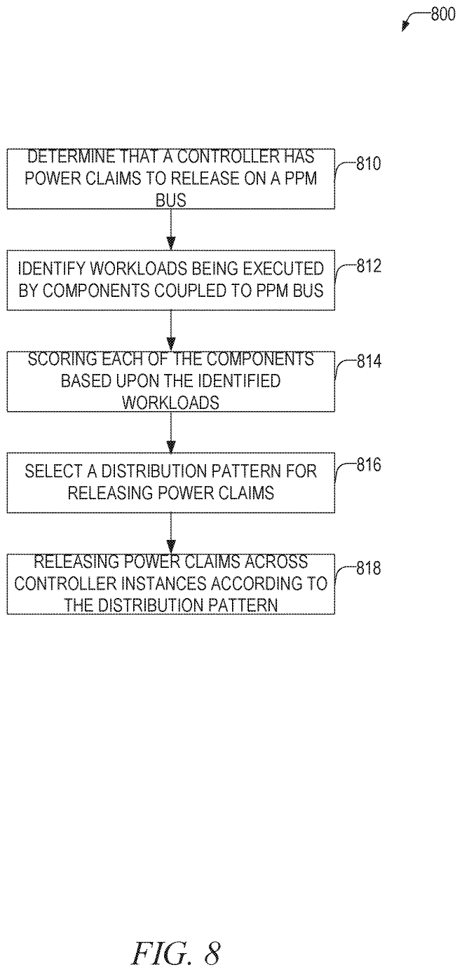

FIG. 8 illustrates a flowchart of a method 800 of ensuring power allocation fairness according to some examples of the present disclosure. At operation 810, the system determines that a controller has power claims to release on a peak power management (PPM) bus, which involves assessing the current power needs and availability within the system. At operation 812, the controller identifies workloads being executed by a plurality of components coupled to the PPM bus, allowing it to understand the power demands of each component. At operation 814, the controller scores each of the components based on the identified workloads, wherein the scoring indicates priority levels for power budget access, taking into account, e.g., factors such as the type of operation being performed and the historical power usage of each component. At operation 816, the controller selects a distribution pattern for releasing power claims across multiple controller instances interleaved with the components along the PPM bus based on the scoring of the memory dies, ensuring that components with higher priority scores receive power allocations first. The distribution pattern specifies which controller instances receive which power allocations to release. Finally, at operation 818, the controller releases power claims across the multiple controller instances according to the distribution pattern to prioritize power budget access for components having higher scores, thereby optimizing the overall performance and efficiency of the system by dynamically managing power distribution. This method addresses potential issues of resource starvation and ensures a fair allocation of power resources among the components, as described in the application and the invention disclosure document.

In some examples, to implement the operations of FIG. 1, operations 812, and 814 are not performed and the distribution pattern selected in operation 816 may be a random distribution pattern.

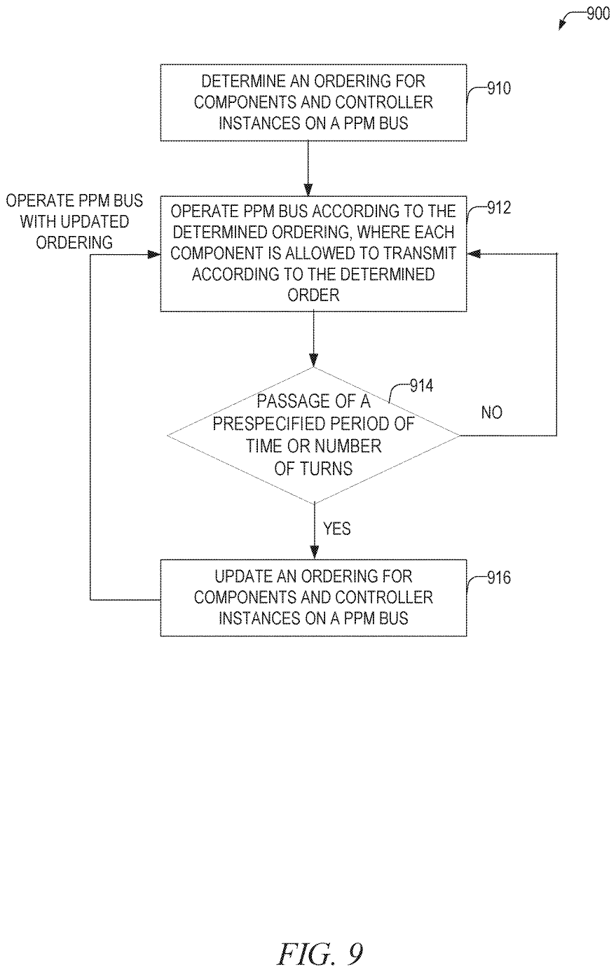

FIG. 9 illustrates a flowchart of a method 900 for modifying a PPM bus ordering to ensure fairness according to some examples of the present disclosure. At operation 910 an initial ordering of the PPM bus components may be determined. That is, which components are given which transmission opportunities on the PPM bus. At operation 912, the PPM bus is operated using this order. At operation 914, a check is made to determine if a predetermined period, time, or number of bus turns have elapsed since the order was determined at operation 910. In some examples, the predetermined number of turns may be a single turn, multiple turns, or the like. If not, then the PPM bus continues to operate according to the order determined in operation 910. At operation 916, the system may update an ordering of the components and/or controller instances on the PPM bus. For example, the system may update the ordering based upon the ordering schemes shown in FIG. 3 or 4. Then flow proceeds to operation 912 where the PPM bus is operated according to the updated ordering.

While the fairness schemes disclosed herein were discussed individually, in some examples, they may be combined. For example, the system may have multiple controller instances spread out across the PPM bus and power to be released may be spread across these instances. In addition, the ordering of these instances and/or the NAND dies may be changed periodically as shown in FIG. 3 or 4.

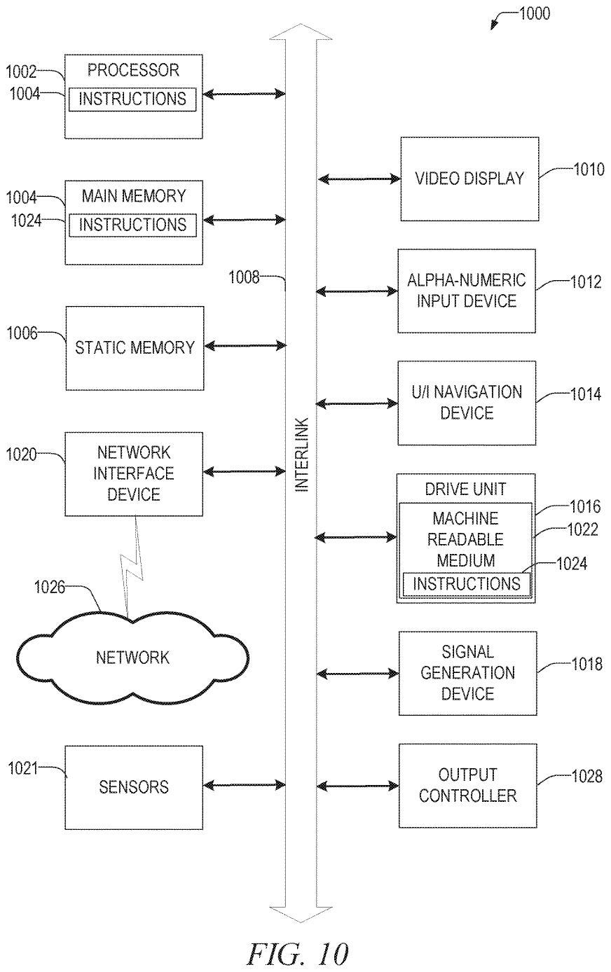

FIG. 10 illustrates a block diagram of an example machine 1000 upon which any one or more of the techniques (e.g., methodologies) discussed herein may be performed. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be in the form of a memory device, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. In some examples, machine 1000 may include memory devices described herein. In some examples, machine 1000 may show components that may be included in a memory device. In some examples, machine 1000 may be configured to implement FIGS. 1-4, be configured as a memory device, such as FIGS. 5 and 7, the computing device of FIG. 6, and/or perform the methods of FIGS. 8 and 9.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 1000 may include one or more hardware processors, such as processor 1002. Processor 1002 may be a central processing unit (CPU), a graphics processing unit (GPU), a hardware processor core, or any combination thereof. Machine 1000 may include a main memory 1004 and a static memory 1006, some or all of which may communicate with each other via an interlink (e.g., bus) 1008. Examples of main memory 1004 may include Synchronous Dynamic Random-Access Memory (SDRAM), such as Double Data Rate memory, such as DDR4 or DDR5. Interlink 1008 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device (e.g., drive unit) 1016, a signal generation device 1018 (e.g., a speaker), a network interface device 1020, and one or more sensors 1021, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine readable media.

While the machine readable medium 1022 is illustrated as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 1024 may further be transmitted or received over a communications network 1026 using a transmission medium via the network interface device 1020. The Machine 1000 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. In some examples, the network interface device 1020 may wirelessly communicate using Multiple User MIMO techniques.

### Other Notes and Examples

Example 1 is a method for managing power in a computing device, comprising: determining that a controller has power Examples to release on a peak power management (PPM) bus; identifying workloads being executed by a plurality of components coupled to the PPM bus; selecting a distribution pattern for releasing power claims across multiple controller instances interleaved with the components along the PPM bus based on priority levels for power budget access of the components based on the identified workloads; and releasing power claims across the multiple controller instances according to the distribution pattern to prioritize power budget access for components having higher scores.

In Example 2, the subject matter of Example 1 includes, adjusting priority levels of each of the components based upon an amount of power allocated to each of the components within a predetermined period of time, the priority levels adjusted to prioritize components that have had less power allocated within the predetermined period of time.

In Example 3, the subject matter of Examples 1-2 includes, wherein priority levels are based upon the operation performed by the particular component that are specified on a table.

In Example 4, the subject matter of Example 3 includes, adjusting the priority levels of each of the components based upon an amount of power allocated to each of the components within a predetermined period of time, the priority levels adjusted to prioritize components that have had less power allocated within the predetermined period of time.

In Example 5, the subject matter of Examples 1-4 includes, wherein the computing device is a memory device, and wherein the plurality of components are memory dies.

In Example 6, the subject matter of Examples 1-5 includes, wherein selecting the distribution pattern for releasing power Examples across multiple controller instances interleaved with the components along the PPM bus based on the priority levels comprises assigning amounts of power to release to each controller instance based upon the priority levels of dies following each controller instance on the PPM bus.

In Example 7, the subject matter of Examples 1-6 includes, wherein determining that a controller has power Examples to release on a peak power management (PPM) bus comprises determining that a workload of the controller requires less power than an amount currently claimed.

Example 8 is a computing device for managing power in a computing device, the computing device comprising: a hardware processor; a memory, the memory storing instructions, which when executed by the hardware processor cause the computing device to perform operations comprising: determining that a controller has power Examples to release on a peak power management (PPM) bus; identifying workloads being executed by a plurality of components coupled to the PPM bus; selecting a distribution pattern for releasing power claims across multiple controller instances interleaved with the components along the PPM bus based on priority levels for power budget access of the components based on the identified workloads; and releasing power claims across the multiple controller instances according to the distribution pattern to prioritize power budget access for components having higher scores.

In Example 9, the subject matter of Example 8 includes, wherein the operations further comprise: adjusting priority levels of each of the components based upon an amount of power allocated to each of the components within a predetermined period of time, the priority levels adjusted to prioritize components that have had less power allocated within the predetermined period of time.

In Example 10, the subject matter of Examples 8-9 includes, wherein priority levels are based upon the operation performed by the particular component that are specified on a table.

In Example 11, the subject matter of Example 10 includes, wherein the operations further comprise: adjusting the priority levels of each of the components based upon an amount of power allocated to each of the components within a predetermined period of time, the priority levels adjusted to prioritize components that have had less power allocated within the predetermined period of time.

In Example 12, the subject matter of Examples 8-11 includes, wherein the computing device is a memory device, and wherein the plurality of components are memory dies.

In Example 13, the subject matter of Examples 8-12 includes, wherein the operation of selecting the distribution pattern for releasing power Examples across multiple controller instances interleaved with the components along the PPM bus based on the priority levels comprises assigning amounts of power to release to each controller instance based upon the priority levels of dies following each controller instance on the PPM bus.

In Example 14, the subject matter of Examples 8-13 includes, wherein the operation of determining that a controller has power Examples to release on a peak power management (PPM) bus further comprises determining that a workload of the controller requires less power than an amount currently claimed.

Example 15 is a non-transitory machine-readable medium, storing instructions for managing power in a computing device, the instructions, which when executed, cause the machine to perform operations comprising: determining that a controller has power Examples to release on a peak power management (PPM) bus; identifying workloads being executed by a plurality of components coupled to the PPM bus; selecting a distribution pattern for releasing power claims across multiple controller instances interleaved with the components along the PPM bus based on priority levels for power budget access of the components based on the identified workloads; and releasing power claims across the multiple controller instances according to the distribution pattern to prioritize power budget access for components having higher scores.

In Example 16, the subject matter of Example 15 includes, wherein the operations further comprise: adjusting priority levels of each of the components based upon an amount of power allocated to each of the components within a predetermined period of time, the priority levels adjusted to prioritize components that have had less power allocated within the predetermined period of time.

In Example 17, the subject matter of Examples 15-16 includes, wherein priority levels are based upon the operation performed by the particular component that are specified on a table.

In Example 18, the subject matter of Example 17 includes, wherein the operations further comprise: adjusting the priority levels of each of the components based upon an amount of power allocated to each of the components within a predetermined period of time, the priority levels adjusted to prioritize components that have had less power allocated within the predetermined period of time.

In Example 19, the subject matter of Examples 15-18 includes, wherein the computing device is a memory device, and wherein the plurality of components are memory dies.

In Example 20, the subject matter of Examples 15-19 includes, wherein the operation of selecting the distribution pattern for releasing power Examples across multiple controller instances interleaved with the components along the PPM bus based on the priority levels comprises assigning amounts of power to release to each controller instance based upon the priority levels of dies following each controller instance on the PPM bus.

In Example 21, the subject matter of Examples 15-20 includes, wherein the operation of determining that a controller has power Examples to release on a peak power management (PPM) bus further comprises determining that a workload of the controller requires less power than an amount currently claimed.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A method for managing power in a computing device, comprising:
determining that a controller has power claims to release on a peak power management (PPM) bus;
identifying workloads being executed by a plurality of components coupled to the PPM bus;
selecting a distribution pattern for releasing power claims across multiple controller instances interleaved with the components along the PPM bus based on priority levels for power budget access of the components based on the identified workloads; and
releasing power claims across the multiple controller instances according to the distribution pattern to prioritize power budget access for components having higher scores.

2. The method of claim 1, further comprising adjusting priority levels of each of the components based upon an amount of power allocated to each of the components within a predetermined period of time, the priority levels adjusted to prioritize components that have had less power allocated within the predetermined period of time.

3. The method of claim 1, wherein priority levels are based upon the operation performed by the particular component that are specified on a table.

4. The method of claim 3, further comprising adjusting the priority levels of each of the components based upon an amount of power allocated to each of the components within a predetermined period of time, the priority levels adjusted to prioritize components that have had less power allocated within the predetermined period of time.

5. The method of claim 1, wherein the computing device is a memory device, and wherein the plurality of components are memory dies.

6. The method of claim 1, wherein selecting the distribution pattern for releasing power claims across multiple controller instances interleaved with the components along the PPM bus based on the priority levels comprises assigning amounts of power to release to each controller instance based upon the priority levels of dies following each controller instance on the PPM bus.

7. The method of claim 1, wherein determining that a controller has power claims to release on a peak power management (PPM) bus comprises determining that a workload of the controller requires less power than an amount currently claimed.

8. A computing device for managing power in a computing device, the computing device comprising:
a hardware processor;
a memory, the memory storing instructions, which when executed by the hardware processor cause the computing device to perform operations comprising:
determining that a controller has power claims to release on a peak power management (PPM) bus;
identifying workloads being executed by a plurality of components coupled to the PPM bus;
selecting a distribution pattern for releasing power claims across multiple controller instances interleaved with the components along the PPM bus based on priority levels for power budget access of the components based on the identified workloads; and
releasing power claims across the multiple controller instances according to the distribution pattern to prioritize power budget access for components having higher scores.

9. The computing device of claim 8, wherein the operations further comprise:
adjusting priority levels of each of the components based upon an amount of power allocated to each of the components within a predetermined period of time, the priority levels adjusted to prioritize components that have had less power allocated within the predetermined period of time.

10. The computing device of claim 8, wherein priority levels are based upon the operation performed by the particular component that are specified on a table.

11. The computing device of claim 10, wherein the operations further comprise:
adjusting the priority levels of each of the components based upon an amount of power allocated to each of the components within a predetermined period of time, the priority levels adjusted to prioritize components that have had less power allocated within the predetermined period of time.

12. The computing device of claim 8, wherein the computing device is a memory device, and wherein the plurality of components are memory dies.

13. The computing device of claim 8, wherein the operation of selecting the distribution pattern for releasing power claims across multiple controller instances interleaved with the components along the PPM bus based on the priority levels comprises assigning amounts of power to release to each controller instance based upon the priority levels of dies following each controller instance on the PPM bus.

14. The computing device of claim 8, wherein the operation of determining that a controller has power claims to release on a peak power management (PPM) bus further comprises determining that a workload of the controller requires less power than an amount currently claimed.

15. A non-transitory machine-readable medium, storing instructions for managing power in a computing device, the instructions, which when executed, cause the machine to perform operations comprising:
determining that a controller has power claims to release on a peak power management (PPM) bus;
identifying workloads being executed by a plurality of components coupled to the PPM bus;
selecting a distribution pattern for releasing power claims across multiple controller instances interleaved with the components along the PPM bus based on priority levels for power budget access of the components based on the identified workloads; and
releasing power claims across the multiple controller instances according to the distribution pattern to prioritize power budget access for components having higher scores.

16. The non-transitory machine-readable medium of claim 15, wherein the operations further comprise:
adjusting priority levels of each of the components based upon an amount of power allocated to each of the components within a predetermined period of time, the priority levels adjusted to prioritize components that have had less power allocated within the predetermined period of time.

17. The non-transitory machine-readable medium of claim 15, wherein priority levels are based upon the operation performed by the particular component that are specified on a table.

18. The non-transitory machine-readable medium of claim 17, wherein the operations further comprise:
adjusting the priority levels of each of the components based upon an amount of power allocated to each of the components within a predetermined period of time, the priority levels adjusted to prioritize components that have had less power allocated within the predetermined period of time.

19. The non-transitory machine-readable medium of claim 15, wherein the computing device is a memory device, and wherein the plurality of components are memory dies.

20. The non-transitory machine-readable medium of claim 15, wherein the operation of selecting the distribution pattern for releasing power claims across multiple controller instances interleaved with the components along the PPM bus based on the priority levels comprises assigning amounts of power to release to each controller instance based upon the priority levels of dies following each controller instance on the PPM bus.

21. The non-transitory machine-readable medium of claim 15, wherein the operation of determining that a controller has power claims to release on a peak power management (PPM) bus further comprises determining that a workload of the controller requires less power than an amount currently claimed.
